(19) United States
(12) Patent Application Publication
(10) Pub. No.: US 2024/0058985 A1
(43) Pub. Date: Feb. 22, 2024

(54) MOLDING TOOL, MOLDING MACHINE AND METHOD FOR MOLDING THREE-DIMENSIONAL ARTICLES

(71) Applicant: Marbach Werkzeugbau GmbH, Heilbronn (DE)

(72) Inventors: Klaus WEIBLER, Bretzfeld-Bitzfeld (DE); Philipp RUEGER, Heilbronn (DE)

(21) Appl. No.: 18/270,276

(22) PCT Filed: Jan. 21, 2022
(86) PCT No.: PCT/EP2022/051333

§ 371 Date: Jun. 29, 2023

(30) Foreign Application Priority Data
Jan. 22, 2021 (DE) 10 2021 101 358.5

(51) Int. Cl. B27N 3/18; B26F 1/44; B27N 3/04

(52) U.S. Cl. CPC B27N 3/18; B26F 1/44; B27N 3/04

(57) ABSTRACT

A mold tool includes: a first tool part and a second tool part that works together with the first tool part. In the closed state, the two tool parts are moved toward one another, and in the open state, the two tool parts are moved away from one another. The mold tool also includes a first mold half in the first tool part and a second mold half in the second tool part. The two mold halves reshape the sheet of material, arranged between the two tool parts, into at least one three-dimensional article when the two tool parts are moved toward one another. The mold tool also includes a cutting device including at least one cutting element and at least one actuating device. The actuating device extends the cutting element in the direction of the sheet of material, to cut the sheet of material.

### TECHNICAL FIELD

This invention relates to the reshaping of laminar sheets of material to form three-dimensional articles. In particular, the invention relates to a mold tool as well as the use of such a mold tool for reshaping a sheet of material into at least one three-dimensional article. The invention also comprises a method for producing at least one three-dimensional article from a laminar sheet of material.

### BACKGROUND

Containers, cups, or capsules made of plastic material, such as, for example, polyethylene terephthalate (PET), polystyrene (PS), or polypropylene (PP), are used for the portioning and packaging of foods on a large scale. For producing such articles, for example, an injection-molding method or a reshaping method, such as, for example, thermoforming, can be used.

During thermoforming, a thermoplastic plastic film is arranged between a tool bottom part and a tool upper part of the thermoforming tool that is used. Subsequently, the open thermoforming tool is closed by having the two tool parts be moved toward one another. The film arranged between the two tool parts is stretched forward using compressed air and/or at least one stretcher in at least one mold cavity of a mold accommodated in the tool bottom part or tool upper part. Using compressed air and/or negative pressure, the stretched-forward film can be completely molded in the at least one cavity, wherein the side wall of the mold cavity and the mold bottom that closes up the cavity define the shape of the article to be molded. Subsequently, the thermoforming tool is opened, i.e., the two tool parts are moved away from one another again, and the molded article can be removed from the thermoforming tool.

In the case of multi-cavity molds, the mold has a number of mold cavities. Thus, a number of articles can be molded simultaneously with a mold cycle. Such mold tools and molding methods for reshaping thermoplastic plastic films or plastic sheets to form three-dimensional articles, in particular containers, cups, or capsules, are known from, for example, the publications EP 1 163 996 B1, DE 20 2018 106 461 U1, and U.S. Pat. No. 6,440,354 B1. Also, a mold tool, which is designed for reshaping fiber-reinforced plastic films, is known from U.S. Pat. No. 5,759,594 A. The mold tool comprises a tool bottom part and a tool upper part as well as a cutting device with a blade arranged in the peripheral direction on the tool bottom part. The blade can be moved using an actuator in order to cut or initiate cutting the sheet of material. Also known from US 2007/0 257 397 A1 is a thermoforming tool with a movable cutting apparatus, which is provided for initiating the cutting of excess material during the reshaping of a sheet of material to form three-dimensional articles.

The advantage of the thermoforming method is that articles can be produced in large quantities in good quality and conveniently. It is disadvantageous, however, that plastic articles that are not disposed of properly harm the environment, since they are not biodegradable. Because of the steady increase of plastic waste, the need is growing for producing containers for portioning food from biodegradable material. In recent years, encouraging attempts have been made to produce containers from natural fibers, in particular from cellulose. For example, in WO 2017/160218 A1, a technique is described in which cellulose fibers are processed to form laminar sheets and then are reshaped to form three-dimensional articles using a compression mold. Reshaping pressures in the range of 1 MPa to 100 MPa as well as temperatures in the range of 100° C. to 300° C. are necessary in order to reshape cellulose sheets to form three-dimensional articles of the desired wall thickness.

Since sheets made of natural fibers, however, by no means have the elasticity properties of thermoplastic materials, the production of containers in large numbers and in consistent quality remains a challenge. The elastic properties of thermoplastic plastic films cannot be achieved even by chemical treatment of natural fiber sheets by means of additives. The result is that during the reshaping process, it can always result again in uncontrolled crack formation in the natural fiber sheets.

It is therefore the object of this invention to provide a reshaping technique that further improves the state of the art and in particular eliminates the above-described problems in the reshaping of sheets of material made of natural fibers.

### SUMMARY

To solve at least the above-mentioned object, according to a first aspect, a mold tool for reshaping a sheet of material into at least one three-dimensional article is provided, wherein the mold tool is designed optionally to take up an open and closed state, wherein the mold tool comprises: a first tool part and a second tool part that works together with the first tool part, wherein in the closed state of the mold tool, the two tool parts are moved toward one another, and wherein in the open state of the mold tool, the two tool parts are moved away from one another; a first mold half arranged in the first tool part and a second mold half arranged in the second tool part, wherein the two mold halves are designed to reshape the sheet of material, arranged between the two tool parts, into at least one three-dimensional article when the two tool parts are moved toward one another; and a cutting device comprising at least one cutting element and at least one actuating device coupled to the at least one cutting element, wherein the at least one actuating device is designed to extend the at least one cutting element in the direction of the sheet of material arranged between the two tool parts in order to cut the sheet of material.

The cutting can comprise in particular a precutting of the sheet of material. The cutting, however, can also comprise a complete cutting (final cutting) of the sheet of material (in order, for example, to separate the formed article from the scrap skeleton of the sheet of material). In particular, the cutting can also comprise a precutting and final cutting of the sheet of material, in order, on the one hand, to precut the sheet of material for the forming of the article and, on the other hand, to separate the formed article completely from the sheet of material (or the scrap skeleton of the sheet of material).

The first tool part can be designed as an upper tool part or as a lower tool part of the mold tool. Correspondingly, the second tool part can be designed as the lower tool part or upper tool part of the mold tool. The first mold half can comprise a positive shape (male part) or a negative shape (female part). Correspondingly, the second mold half can comprise a negative shape (female part) or positive shape (male part) corresponding to the first mold half. The positive shape can comprise at least one form punch. The negative shape can comprise at least one mold cavity corresponding to at least one form punch. Regardless of the actual implementation, the two mold halves are designed to work together in the closed state of the mold tool in such a way that they reshape the sheet of material arranged in-between to form the at least one desired three-dimensional article.

Below, the terms “open state” and “closed state” are further defined. In the “open state,” the two tool parts (and thus also the two mold halves) of the mold tool are moved away from one another. In this state, a sheet of material can be arranged between the two tool parts or mold halves (for example, using a conveying device). Also, in the open state, an article formed in the mold tool can be removed from the mold tool (for example using a removing device). In the “closed state,” however, both tool parts (and thus also the mold halves arranged in the two tool parts) are moved toward one another. In the closed state, the two mold halves occupy their final mold positions, in which the article obtains its final shape.

The at least one actuating device can be designed to extend the at least one cutting element in the direction of the sheet of material when the mold tool is in the open state or in a partially open state. “Partially open state” means a state of the mold tool in which the two tool parts (and their mold halves) are at least far enough from one another that the sheets of material arranged in-between are not (significantly) deformed or reshaped by the two mold halves. The at least one cutting element can be extended until it comes into contact with at least one opposing cutting element of the mold tool arranged opposite and cuts (or punches) the sheets of material in-between. As an alternative, the at least one cutting element can be extended to a preset position. Then, the tool part that is opposite to the at least one cutting element with the at least one opposing cutting element can be moved as far as to the at least one cutting element until the at least one opposing cutting element comes into contact with the at least one cutting element and cuts (or punches) the sheet of material arranged between the opposing cutting element and the cutting element. The preset extension position can be directly below or above the sheet of material. By extending the at least one cutting element, it is possible to cut (precut) the sheet of material (locally) before the sheet of material is (significantly) reshaped.

The at least one actuating device can also be designed in such a way that at least one cutting element is retracted again after the cutting (precutting) of the sheet of material. After retracting the at least one cutting element, the two tool parts and their mold halves can be moved further toward one another and in this case reshape the sheet of material to form at least one article.

The at least one cutting element can be designed and arranged in the mold tool in such a way that in the extension position, it at least partially precuts or cuts the sheet of material on the outer edge of the article to be molded or close to the outer edge of the article to be molded. The partial precutting can comprise a locally limited cutting of the sheet of material in areas in which in the reshaping process, high deformation forces (tensile stresses) arise (for example, on the outside edges of the article). As an alternative, it is also conceivable that the at least one article is completely precut in the peripheral direction. In this case, the precut corresponds identically to a final cut, in which the article to be formed is separated from the residual sheet of material. In both cases, the cut is made with the at least one cutting element essentially before the reshaping of the sheet of material to form the at least one three-dimensional article. The precutting of the sheet of material before the reshaping described here ensures that the sheet of material to be reshaped “flexibilizes” to a certain extent. The sheet of material can be more easily reshaped, and low deformation forces act on the sheet of material, thus eliminating or at least greatly reducing the occurrence of uncontrolled cracks in the sheet of material.

As an alternative, it is also conceivable that after it is reshaped using the at least one extendable cutting element, the at least one article is cut out of the sheet of material (final cut). The cutting-out (final cutting) can in this case be done by extending the corresponding cutting element with the mold tool partially or fully open.

The at least one cutting element can be arranged in the first tool part and/or in the second tool part. In particular, the at least one cutting element can be arranged close to the first mold half and/or second mold half. The at least one cutting element is thus a part of the mold tool, whereby an especially compact design is achieved.

The at least one actuating device, which is provided for retracting and extending the at least one cutting element, can also be arranged in the first tool part and/or in the second tool part. The at least one actuating device can thus also be a component of the mold tool. In this way, an especially compact design is achieved, so that the mold tool can be mounted in a conventional molding machine/compression mold.

The cutting device can also comprise an opposing cutting element that works together with the at least one cutting element. This opposing cutting element can be arranged in a tool part opposite to the at least one cutting element. If the cutting element is arranged in the first tool part, the opposing cutting element can be arranged in the opposite second tool part. If, however, the at least one cutting element is arranged in the second tool part, the opposing cutting element can be arranged in the first tool part.

The at least one extendable cutting element can comprise at least one blade. The blade can comprise, for example, a wedge-action blade or another knife. The opposing cutting element can comprise a cutting support that works together with the at least one blade.

The at least one actuating device can comprise an extending and retracting mechanism. The latter is provided to extend and again retract the at least one cutting element, if necessary. To this end, the extending and retracting mechanism is coupled mechanically to the at least one cutting element. For coupling, for example, a carrier element or a carrier plate can be provided, which occupies the at least one cutting element on one side and is in contact with the retracting and extending mechanism on the opposite side. The retracting and extending mechanism can be implemented in the form of a piston-cylinder device that can be actuated pneumatically or hydraulically. As an alternative, it is also conceivable that the retracting and extending mechanism is implemented in the form of an electromechanical actuating device.

Also, the at least one actuating device can comprise a support mechanism. The support mechanism can be provided to support the at least one cutting element during the cutting process. The support mechanism is used to reduce stress in the extending and retracting mechanism, since during cutting (punching), considerable compressive forces act on the at least one cutting element and the extending and retracting mechanism coupled to the at least one cutting element.

In addition to the above-described extendable cutting element, the mold tool can comprise at least one cutting line arranged in the first and/or second tool part. The at least one cutting line arranged in the first and/or second tool part can be configured to separate (to completely cut out) the at least one formed article from the sheet of material after the reshaping process. The at least one cutting line can be designed in the form of a steel strip line.

When the complete cutting-out of the at least one formed article from the sheet of material is done by the above-described cutting device with the at least one extendable cutting element, the additional cutting line/cutting edge arranged on the first and/or second tool part can also be omitted.

The sheet of material to be reshaped can consist primarily of fibers, in particular natural fibers. The natural fibers can be plant fibers or fibers of animal origin. In particular, the fibers can be cellulose fibers.

According to another aspect of the invention, a use of the above-mentioned mold tool for producing at least one three-dimensional article from a laminar sheet of material is provided. The sheet of material can in this connection consist in particular of natural fibers. According to one implementation, the natural fibers can comprise cellulose. The article can be, for example, a container, a cup, a capsule, a cover, or another three-dimensional article.

According to another aspect of the invention, a molding machine, in particular a compression mold, is provided for producing at least one article from a laminar sheet of material. The molding machine comprises the above-described mold tool with a first mold tool part and a second mold tool part; an over-table for accommodating the first mold tool part; and an under-table for accommodating the second mold tool part, wherein the over-table and/or the under-table is/are mounted in a movable manner.

The molding machine can be configured to transfer a preset cavity pressure to the mold tool. Also, the molding machine can comprise a conveying device, which is designed to feed the sheet of material to the mold tool (intermittently).

According to another aspect of the invention, a method for producing at least one three-dimensional article, in particular a cup, from a laminar sheet of material is provided, wherein the method comprises the following steps: provision of the above-mentioned mold tool; arrangement of the laminar sheet of material between the two mold halves of the mold tool; extension of the at least one cutting element of the mold tool in the direction of the sheet of material arranged between the two tool parts; cutting of the sheet of material using at least one cutting element with an open or at least partially open mold tool; retraction of the at least one cutting element, after the sheet of material was cut; and (subsequent) closing of the mold tool and reshaping of the sheet of material to form at least one three-dimensional article.

The sheet of material can be in particular a laminar sheet of material made of natural fibers, in particular cellulose fibers.

The step of arranging the laminar sheet of material between the two mold halves can then always take place when the mold tool is in the open state, i.e., when the two tool parts with the corresponding mold halves are moved away from one another, as was further described above. The laminar sheet of material can be fed (intermittently) to the mold tool using a conveying device and thus can be arranged between the two tool parts.

The step of extending the at least one cutting element can comprise a positioning of the at least one cutting element directly below or above the sheet of material. “Directly below or above the sheet of material” can mean a position in which the at least one cutting element is positioned in the extended state in immediate proximity below or above the sheet of material arranged between the two tool parts, without touching the sheet of material. Also, the subsequent step of cutting using the at least one cutting element can comprise a movement of the tool part, opposite to the at least one cutting element, in the direction of the extended cutting element, until the at least one opposing cutting element (or the cutting support of the opposing cutting element) comes into contact with the at least one cutting element. By bringing the cutting element and cutting support of the opposing cutting element into contact, the sheet of material lying in-between is severed in the area of the cutting element.

The step of cutting using the extendable cutting element can thus comprise a precutting of the sheet of material at preset positions in order to prevent an uncontrolled crack formation in the subsequent reshaping process. The precutting of the sheet of material can be done in locally limited areas of the sheet of material that lie in the immediate proximity of the cup edge. The final cut for separating the formed article from the sheet of material can be done in a subsequent cutting with a cutting line that is different from the extendable cutting element when the tool is closed (so-called final cut).

The step of retracting the at least one extended cutting element can comprise a slight moving away of the tool part with the opposing cutting element from the tool part with the at least one cutting element in order to release the at least one cutting element for retraction. As an alternative, it is also conceivable that the at least one cutting element is retracted, without the tool part that is opposite to the at least one cutting element moving away from the latter. After retracting or even during retraction, the two tool parts can be moved toward one another in order to be transferred into the final mold position.

According to another aspect of the invention, a method for producing at least one three-dimensional article, in particular a cup, from a laminar sheet of material is provided, wherein the method comprises the following steps: provision of the above-mentioned mold tool; arrangement of the laminar sheet of material between the two mold halves of the mold tool; closing of the mold tool and reshaping of the sheet of material to form at least one three-dimensional article; extension of the at least one cutting element of the mold tool; and cutting-out, using at least one extended cutting element, of the at least one three-dimensional article from the sheet of material.

The at least one cutting element of the mold tool can be extended in the case of an open or at least partially open mold tool.

The step of cutting out the at least one three-dimensional article can also take place in the case of an open or at least partially open mold tool. By moving at least one of the two mold tool parts, the at least one extended cutting element can be moved toward the opposing cutting element arranged opposite to the at least one cutting element, thus cutting the sheets of material, arranged between the at least one extended cutting element and opposing cutting element, with (a) formed article(s). As an alternative, the at least one cutting element can be extended to the point where it comes into contact with the opposite opposing cutting element, thus cutting the sheets of material arranged in-between with (a) formed article(s).

The extended cutting element can be retracted again after the cutting-out of the at least one three-dimensional article.

### BRIEF DESCRIPTION OF THE DRAWINGS

Additional details and advantages of the invention are further described based on the embodiments shown in connection with the figures. The drawings include:

FIG. 1 shows a depiction of a mold tool according to this invention;

FIG. 2 shows a flow diagram for illustrating a method for reshaping laminar sheets of material according to this invention;

FIGS. 3a to 3j show depictions of another mold tool for reshaping a sheet of material; and

FIG. 4 shows depictions of another mold tool for reshaping a sheet of material.

### DETAILED DESCRIPTION

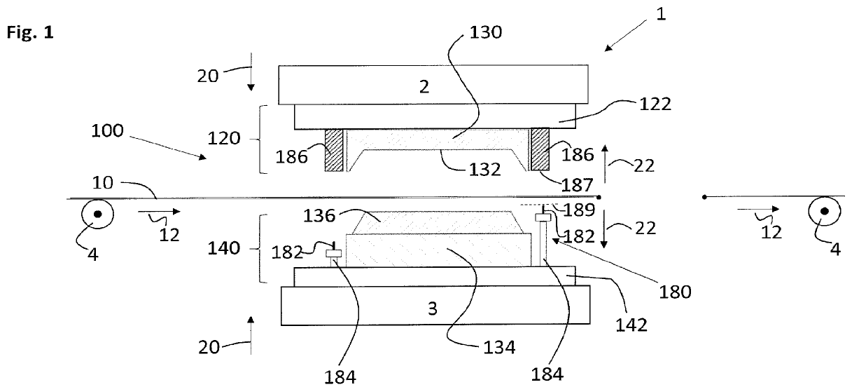

FIG. 1 shows a mold tool 100 according to the invention, which is incorporated in a molding machine 1. The molding machine 1 is indicated only diagrammatically by an over-table 2 and an under-table 3.

The mold tool 100 comprises a first tool part 120 as well as a second tool part 140. In the implementation shown in FIG. 1, the first tool part 120 is designed as an upper tool part and the second tool part 140 is designed as a lower tool part of the mold tool 100. The first tool part 120 is mounted on the over-table 2 and the second tool part 140 is mounted on the under-table 3 of the molding machine 1. As is also indicated from FIG. 1 by the arrows 20 and 22, at least one of the two tables 2 and 3 can be moved in the vertical direction (i.e., perpendicular to the planes of the two tables 2, 3). Thus, the two tool parts 120, 140 in the molding machine 1 are mounted in a movable manner. They can be moved toward one another (depicted by the arrow 20 on the left) or moved away from one another again (depicted by the arrow 22 on the right). Correspondingly, the mold tool 100 can occupy a closed state (position) when the two tool parts 120, 140 are (completely) moved toward one another, or they can occupy an open state (position) when the two tool parts 120, 140 are (completely) moved away from one another. In the depiction shown in FIG. 1, the mold tool 100 is in the open state, i.e., the two tool parts 120, 140 are moved away from one another.

The first tool part 120 comprises a first mold half 130 (also called upper mold half 130 below), which is designed as a negative shape (female part) and has at least one cavity 132. The first mold half 130 is mounted on a first carrier device 122 of the first tool part 120. The second tool part 140 comprises a second mold half 134, corresponding to the first mold half 130, which second mold half 134 is designed as a positive shape (male part) and has at least one punch 136 corresponding to the cavity 132. The second mold half 134 is mounted on a second carrier device 142 of the second tool part 140. For this invention, it does not matter what the actual configuration of the two mold halves 130, 134 is. According to an alternative implementation, it is also conceivable that the first mold half 130 is designed as a male part, and the second mold half 134 is designed as a female part. It is crucial only that the two mold halves 130, 134 work together in the closed state in such a way that they reshape a sheet of material 10 mounted between the two mold halves 130, 134 in order to reshape the at least one desired article.

The sheet of material 10 to be reshaped can be made of natural fibers or another recyclable material. As natural fibers, plant fibers or fibers of animal origin can be used. In particular, the sheet of material can have fibers made of cellulose.

As is also indicated in FIG. 1, the sheet of material 10 to be reshaped can be fed (intermittently) to the mold tool 100 using a conveying device 4. The conveying device 4 can be part of the molding machine 1 and is indicated only diagrammatically by two rollers (see rollers 4) in FIG. 1. The direction of conveyance is indicated by the arrows 12.

The mold tool 100 also comprises a cutting device 180. The cutting device 180 comprises at least one cutting element 182 and at least one actuating device 184 coupled to the at least one cutting element 182. The at least one actuating device 184 is provided for the purpose of extending or again retracting the at least one cutting element 182 optionally in the direction of the sheet of material 10 to be reshaped. The extension position 189 of the at least one cutting element 182 is depicted on the right in the figure. On the left in FIG. 1, the at least one cutting element 182 can be seen in its retracted position. By extending the at least one cutting element 182, it is possible to cut, in particular to precut, the sheet of material 10 even before the sheet of material 10 has experienced a significant reshaping. A configuration of the at least one cutting element 182 in such a way that the at least one article formed in the sheet of material 10 can be completely cut out using at least one extendable cutting element 182 is also conceivable. This cutting process or cutting-out process is described in even greater detail below in connection with the subsequent figures.

The at least one cutting element 182 and the at least one actuating device 184 are arranged in the lower tool part 140. An arrangement in the upper tool part 120 is also conceivable, however. Regardless of the arrangement in the lower tool part 140 or upper tool part 120, the at least one cutting element 182 is arranged close to the second mold half 134 or first mold half 130 in such a way that the at least one cutting element 182 in the extended position cuts, in particular precuts, the sheet of material 10 close to the article 10 to be molded. In particular, the at least one cutting element 182 can be oriented relative to the mold halves 130, 134 in such a way that it precuts the sheet of material 10 locally in those areas (positions) where in the subsequent reshaping process, strong deformations and thus strong deformation forces (tensile forces) arise. Such areas of strong deformation and thus higher deformation forces are, for example, the corner areas of an article. By local precutting of the sheet of material in the corner area, the sheet of material 10 can be locally “flexibilized,” thus considerably reducing the tensile forces that arise during reshaping and thus making it possible to prevent uncontrolled crack formations in the sheet of material 10.

In addition to the local cutting or precutting described here, it is also conceivable that the at least one cutting element 182 is designed and arranged in such a way that it completely cuts the sheet of material 10 along or close to the outer peripheral edge of the article to be molded. In this implementation, the cut is a final cut, in which the area of the sheet of material that is reshaped or is to be reshaped into the article is separated from the residual sheet of material before/after it is/was reshaped. Correspondingly, the at least one cutting element 182 is designed and arranged on the lower tool part 140 or upper tool part 120 in such a way that it (completely) surrounds the corresponding mold halves 130 or 134 along the outside periphery thereof.

The cutting device 180 can also comprise at least one opposing cutting element 186. The at least one opposing cutting element 186 is arranged opposite the at least one cutting element 182. In the implementation shown in FIG. 1, the at least one opposing cutting element 186 is arranged on the upper tool part 120. If the at least one cutting element 182 in the upper tool part 120 is arranged in ways other than the implementation shown in FIG. 1, the opposing cutting element 186 is arranged opposite on the lower tool part 140. The at least one opposing cutting element 186 comprises at least one opposing cutting support 187, against which the at least one cutting element 182 is pressed when the sheet of material is cut.

For the sake of simplicity, FIG. 1 shows the mold tool 100 with only one shape. It is understood that the mold tool 100 described here can also be a multi-cavity mold, comprising a number of (identical or different relative to one another) shapes with corresponding mold cavities 132 and form punches 136 corresponding thereto. The latter are arranged beside one another (for example in matrix form) in the upper tool part 120 and the lower tool part 140. In such a multi-cavity mold, at least one cutting element 182 is provided for each shape. The cutting elements 182 assigned to the respective shapes can be actuated together (i.e., extended and retracted again) by a common actuating device. As an alternative, it is also conceivable that for each shape, a separate actuating device 184 is provided for actuating the cutting element 182 belonging to each shape.

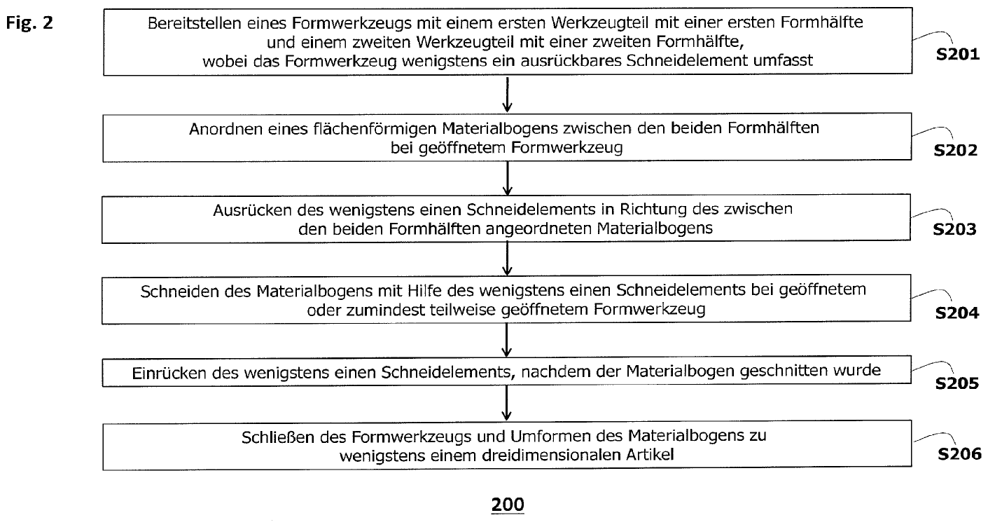

A function of the mold tool 100 described in connection with FIG. 1 is further described based on the flow diagram in FIG. 2. FIG. 2 describes a method 200 for producing at least one article, wherein the method 200 is performed using the tool 100.

In a first step S201 of the method 200, the above-described mold tool 100 is provided. The provision can comprise a mounting of the mold tool 100 in a molding machine 1 (compression mold). The two tool parts 120, 140 are movably mounted relative to one another in the molding machine 1 of the mold tool 100. Movably mounted means that at least one of the two tool parts 120, 140 can move with its mold halves 130, 134, so that the mold tool 100 can cycle into an open state and a closed state.

In the open state of the mold tool 100 (i.e., when the two tool parts 120, 140 are moved apart), a laminar sheet of material 10 is arranged between the two tool parts 120, 140 (or the mold halves 130, 140 thereof) in a next step S202. The arrangement can be done using a conveying device 4, as briefly described in connection with FIG. 1. FIG. 1 shows the mold tool 100 in the open state as well as the arrangement of the sheet of material 10 to be reshaped between the two tool parts 120, 140.

In a subsequent step S203, in the case of an open or even partially open mold tool 100, the at least one cutting element 182 arranged in the mold tool 100 is extended in the direction of the sheet of material 10 arranged between the two tool parts 120, 140. Using the actuating device 184 described in FIG. 1, the extension is done essentially perpendicular to the direction of forward motion of the sheet of material 10. The direction of forward motion is indicated in FIG. 1 with the arrows 12.

In the subsequent step S204, the sheet of material 10 is cut using the at least one cutting element 182. The cutting step is carried out when the at least one cutting element 182 is brought into contact with the at least one opposite opposing cutting element 186 (or its opposing cutting support 187). This can take place by, for example, the at least one cutting element 182 being extended until it comes into contact with the at least one opposing cutting element 186 (or the opposing cutting support 187 of the opposing cutting element 186). As an alternative, the at least one cutting element 182 can be extended to a preset position (only just) below or above the sheet of material 10 (see position 189 in FIG. 1), and then the lower tool part 140 is moved in the direction of the upper tool part 120 or the upper tool part 120 is moved in the direction of the lower tool part 140 or both tool parts 120, 140 are moved relative to one another until the at least one cutting element 182 comes into contact with the corresponding opposing cutting element 186 (or its cutting support 187). If the at least one cutting element 182 comes into contact with the opposite opposing cutting element 186, the sheet of material 10 arranged in-between at corresponding positions is cut or punched. Since the at least one cutting element 182 is extended using the at least one actuating device 184, this cut is carried out with the open or at least even partially open mold tool 100. Partially open mold tool 100 means a state in which the two tool halves 120, 140 lie at least far enough apart that they do not significantly deform or reshape the sheet of material 10 lying in-between.

In the subsequent step S205, after cutting (precutting) the sheet of material 10 using the at least one cutting element 182, the at least one cutting element 182 is retracted again. The step of retraction S205 is carried out using the at least one actuating device 184, which returns from its extended state into the retracted state (base state).

In the following step S206, the mold tool 100 is closed, i.e., the two mold tool parts 120, 140 are completely moved toward one another. As a result, the sheet of material 10 arranged between the two mold halves 130, 134 is reshaped to form a three-dimensional article. During reshaping, the sheet of material to be reshaped can be heated to a desired mold temperature. Typical mold temperatures for reshaping sheets of material made of natural fibers are in the range of 50° C. to 300° C. The desired mold temperature can be generated by a heating device arranged in the mold tool 100. Also, a desired cavity pressure can be exerted on the mold tool 100 by means of the molding machine 1. Typical cavity pressures in the case of sheets of material made of natural fibers are in the range of 1 MPa to 100 MPa. The actual mold temperature and cavity pressure are set individually based on the material of the sheet of material 10 to be reshaped as well as on the geometry of the article to be produced. The article produced can be a container, cup, or capsule for portioning food.

In order to separate from the sheet of material 10 the article produced, in addition a cutting line or cutting edge can be integrated into the mold tool 100. The latter is attached and shaped in the upper tool part 120 or lower tool part 140 in such a way that in the case of the closed mold tool 100, it cuts or punches the sheet of material 10 along the outside edge of the article. As an alternative, it is also conceivable that the sheet of material 10 is fed with the at least one formed article to a downstream punching station, which punches out the at least one formed article.

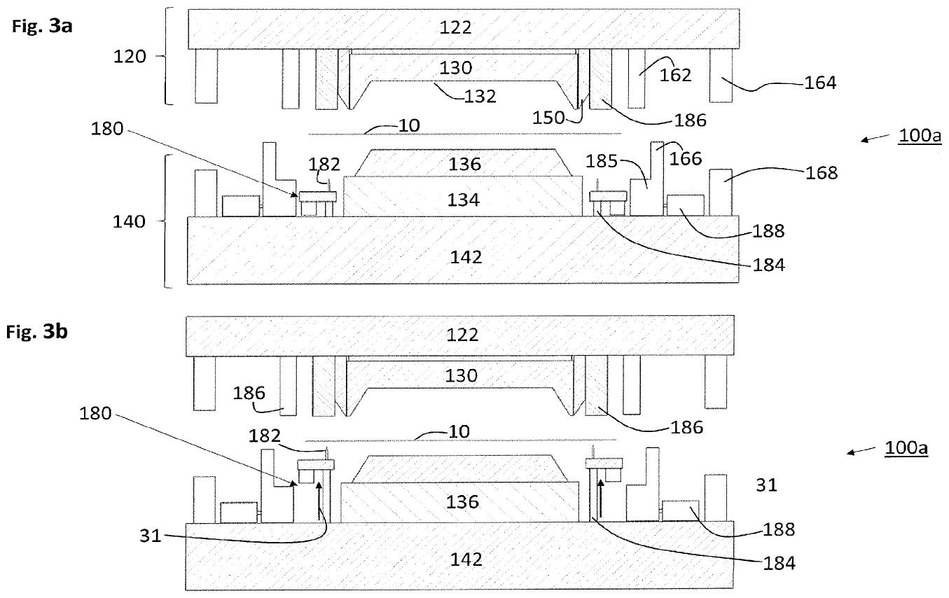

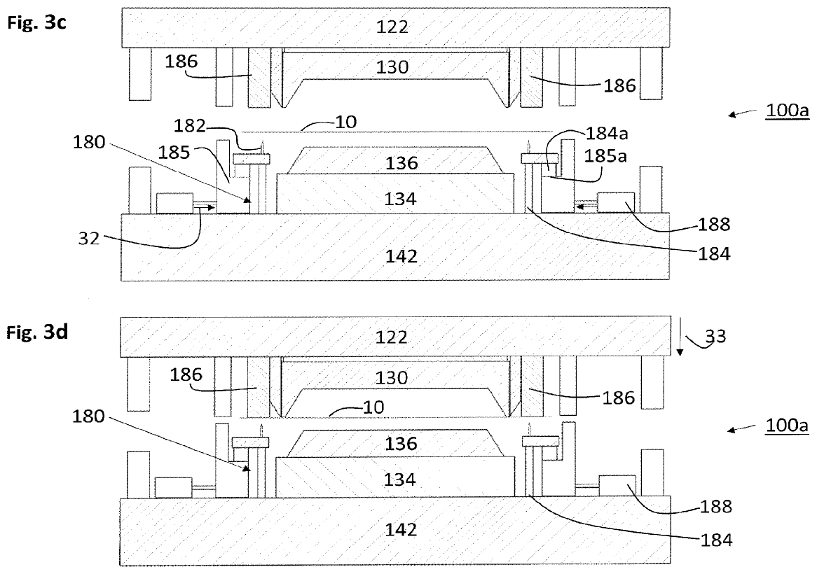

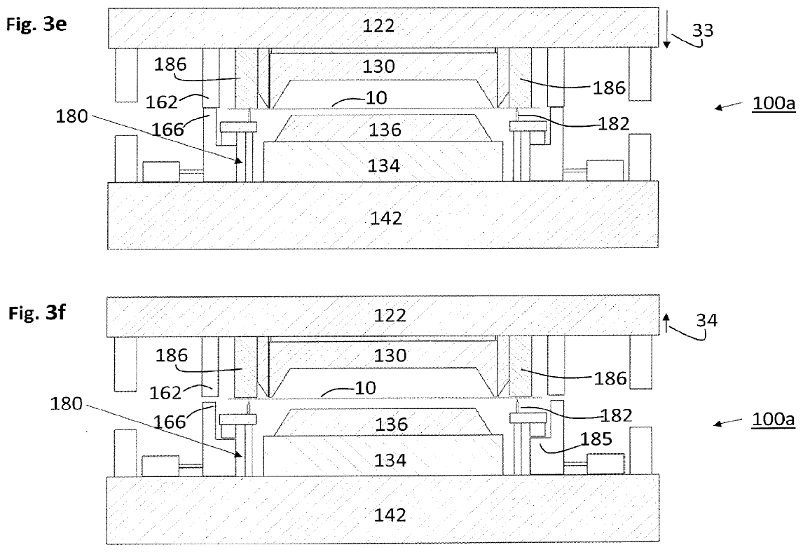

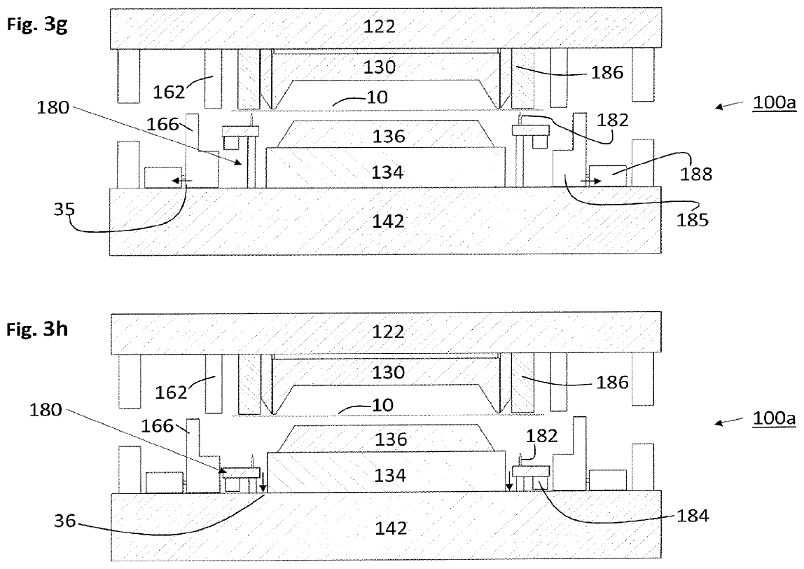

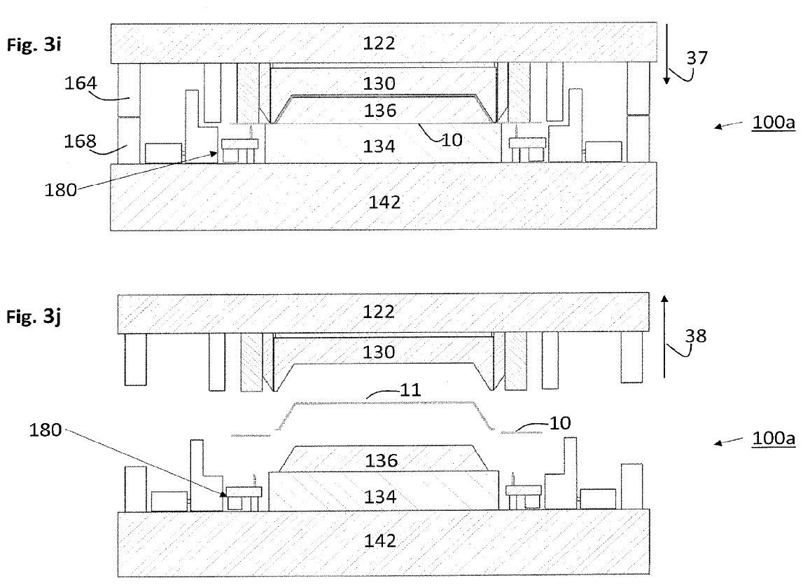

In connection with FIGS. 3a to 3j, a mold tool 100a is described, which depicts a further development of the mold tool 100 discussed in connection with FIG. 1. In FIGS. 3a to 3j, features and tool elements that are similar or identical to the mold tool 100 in FIG. 1 are provided with the same reference numbers.

FIG. 3a shows the mold tool 100a in the open state. The mold tool 100a comprises a first (upper) tool part 120, which comprises a first carrier device 122 and a first (upper) mold half 130 arranged on the carrier device 122. The first mold half 130 is in turn designed as a negative shape (female part) with at least one cavity 132. The first carrier device 122 can be designed in the form of a carrier plate. The upper tool part 120 also comprises at least one opposing cutting element 186 with a cutting support 187, as discussed in connection with FIG. 1. The upper tool part 120 also comprises a cutting line (or cutting edge) 150 surrounding the first mold half 130 in the peripheral direction, which cutting line is provided for final cutting of a reshaped article and is even further described below in connection with FIG. 3i. Furthermore, the mold tool 100a can have at least one upper stop element 162 for the precut further described below and an upper stop element 164 for the final cut.

The mold tool 100 according to FIG. 3a also comprises a second (lower) tool part 140, which comprises a second carrier device 142 and a second (lower) mold half 134 arranged on the carrier device 142. The second mold half 134 is in turn designed as a positive shape (male part) with at least one punch 136 that works together with the cavity 134. The second carrier device 142 can in turn be designed in the form of a carrier plate. The lower tool part 140 also comprises a cutting device 180 with at least one cutting element 182 and at least one actuating device 184 coupled to the at least one cutting element 182. In FIGS. 3a to 3j, two cutting elements 182 (and two actuating devices 184) can be seen, which flank the lower mold half 134. It is understood that the mold tool 100a can, as an alternative, also have three or more cutting elements 182 flanking the lower mold half 134. The at least one actuating device 184 can be designed as a pneumatic, hydraulic, or electromechanical actuating device. The at least one cutting element 182 can be implemented as a blade, preferably as a wedge-action knife.

As an alternative to the mold tool 100 in FIG. 1, the mold tool 100a also comprises a support mechanism. The support mechanism comprises at least one support element 185, which is coupled to at least one second actuating device 188. The at least one second actuating device 188 and the at least one support element 185 are arranged in the lower tool part 140. The at least one support element 185 has a support surface 185a (see FIG. 3c) as well as a lower stop element 166 for the precut. The at least one second actuating device 188 can in turn be designed as a pneumatic, hydraulic, or electromechanical actuating device. The function of the at least one support element 185 and the at least one second actuating device 188 is described in detail in connection with the subsequent figures.

Furthermore, the lower tool part 140 can have at least one lower stop element 168 for the final cut corresponding to the at least one stop element 164 of the upper tool part 120. The function of the stop elements 164 and 168 is further described below in more detail.

In connection with FIGS. 3a to 3j, the production of at least one article 11 (see FIG. 3j) from a laminar sheet of material 10, in particular from a natural fiber sheet, using the mold tool 100a is now further described. FIGS. 3a to 3j show the actuation of the mold tool 100a during a reshaping cycle.

In FIG. 3a, the mold tool 100a is in the open state, in which the two tool parts 120, 140 are moved apart. The sheet of material 10 to be reshaped (for example using a conveying device) is positioned between the two tool parts 120, 140. The at least one cutting element 182 of the cutting device 180 is still in the retracted state in FIG. 3a. The positioned sheet of material 10 can be, for example, a sheet of material made of natural fibers, in particular cellulose.

In FIG. 3b, the mold tool 100a is in addition in the open state or at least even in a partially open state. The at least one cutting element 182 is extended using the at least one actuating device 184 coupled to the at least one cutting element 182. In this connection, the at least one cutting element 182 is moved essentially perpendicular from the carrier device 142 of the lower tool part 140 in the direction of the superjacent sheet of material 10. This extending movement is indicated in FIG. 3b with the arrows 31. The at least one cutting element 182 is extended until the cutting element 182 or the point of the at least one cutting element 182 is located just below the sheet of material 10. In the extended position, the at least one cutting element 182 does not even touch the sheet 10.

Using the at least one second actuating device 188, the at least one support element 185 is now moved in the direction of the at least one extended cutting element 182, so that at least one section (see section with support surface 185a in FIG. 3c) of the at least one support element 185 engages from below the at least one cutting element 182.

In the implementation shown in FIG. 3c, the at least one support element 185 is moved horizontally inward (see arrow 32 in FIG. 3c). As a result, a support element 184a of the actuating device 184 can rest on the support surface 185a of the at least one support element 185. The at least one support element 185 thus has the function of supporting the at least one cutting element 182 in the cutting process and thus of reducing stress on the actuating device 184. The cutting forces (punching forces) that act on the cutting element 182 during cutting (punching) stress the support element 185. Thus, the actuating device 184, which implements, for example, a pneumatic or hydraulic stroke mechanism, reduces stress.

Following this, the upper tool part 120 is now lowered until the upper stop element 162 comes into contact with the lower stop element 166. This lowering movement of the upper tool part 100a is depicted by arrows 33 pointing downward in FIGS. 3d and 3e. Because of the lowering movement, the upper tool part 120 comes into contact with the sheet of material 10 (see FIG. 3d) and presses the latter in the direction of the at least one cutting element 182. As a result, the sheet 10 is precut or pre-punched on the site of the at least one extended cutting element 182, even before the sheet 10 experiences a significant reshaping (see FIG. 3e). This precut serves as a controlled pressure-reduction step and causes the laminar sheet 10 to be more easily reshaped into a three-dimensional form.

As diagrammatically indicated in FIGS. 3a to 3j, the at least one cutting element is arranged on or close to the outside edge of the mold (or the two mold halves 130, 134) and thus produces a cut in the sheet 10 in or close to the outside edge of the article 11 to be produced, where the transition is from the laminar sheet to the three-dimensional article. There, the maximum reshaping forces (tensile forces) arise during reshaping. In this way, uncontrolled cracks can be eliminated or greatly reduced during the reshaping, thus greatly reducing the scrap of defective articles.

Subsequent to the cutting process, the top tool 120 is now also slightly raised. This is illustrated by arrow 34 in FIG. 3f. By the stroke movement, the upper tool part 120 is also slightly moved away from the lower tool part 140. As a result, the at least one opposing cutting element 186 can be detached from the underlying, extended, and supported cutting element 182. There is now no longer a significant load on the at least one cutting element 182, so that the at least one support element 185 can be moved away again, i.e., from the at least one cutting element 182, by the at least one second actuating device 188 horizontally outward. This horizontal movement of the support element 185 outward is indicated by arrow 35 in FIG. 3g.

Following this, the at least one cutting element 182 that is no longer supported can be retracted again using the at least one actuating device 184. This movement is indicated by arrow 36 in FIG. 3h, wherein FIG. 3h shows the state in which the at least one cutting element 182 is completely retracted.

The upper tool part 120 is now lowered onto the lower tool part 140 (see arrow 37 in FIG. 3i) until the upper stop element 164 comes into contact with the corresponding lower stop element 168. The mold tool 100a is now closed (see FIG. 3i). By lowering the upper tool part 120 onto the lower tool part 140, the sheet of material 10 arranged between the two mold halves 130, 134 is reshaped to form the at least one article 11. Furthermore, the at least one article 11 is final-cut on its outside edge using the cutting line 150 (or cutting edge) as soon as the mold tool 100a is closed. Final cutting means that the formed article 11 is separated from the sheet of material 10. The reshaping of the sheet of material 10 to form the three-dimensional article 11 is now finished.

The upper tool part 120 is now moved away again, i.e., raised, from the lower tool part 140. This stroke movement is illustrated by arrow 38 in FIG. 3j. FIG. 3j shows the mold tool 100a again in the open state (starting position). The article 11 can be removed using a removing device (not depicted in FIG. 3j). Following this, a section of the sheet of material 10 can be moved up using a conveying device, not depicted in more detail. Then, a new mold cycle can begin.

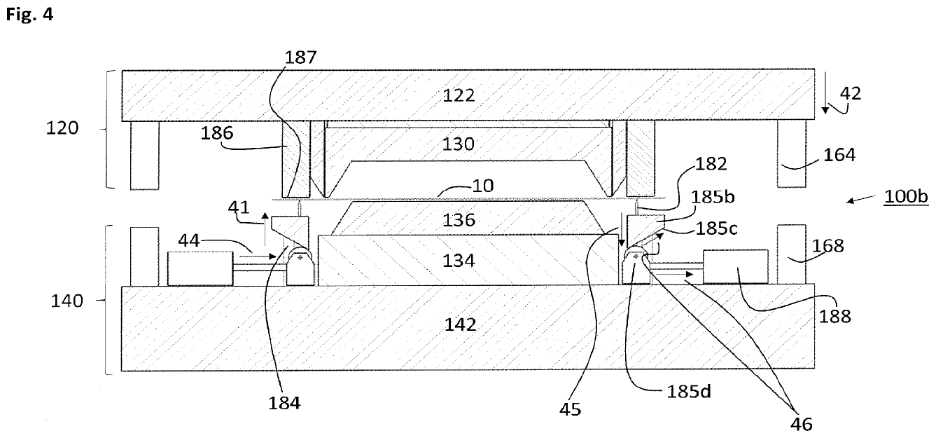

In connection with FIG. 4, another mold tool 100b is described, which is distinguished from the mold tool 100a of FIGS. 3a to 3j primarily in the support mechanism. The latter is described in more detail below. All other elements of the mold tool 100b are identical or serve the same function as the elements in the mold tool 100a and are therefore not described again. Reference is rather made above to the corresponding description of the mold tool 100a in connection with FIGS. 3a to 3j.

FIG. 4 shows the mold tool 100b in a partially open state, in which the sheet of material 10 between the two mold halves 130, 134 is still not significantly deformed. The at least one cutting element 182 is in its extended position below the sheet of material 10. The extension of the at least one cutting element 182 can be done using the at least one actuating device 184, as further described above in connection with FIG. 3b and the mold tool 100a. The extending movement is indicated by the arrow 41 in FIG. 4.

The support mechanism of the mold tool 100b comprises at least one second actuating device 188 and at least one roller element 185d coupled to the at least one second actuating device 188. The at least one roller element 185d is arranged in such a way that at least one support element 185b can unroll onto a tilted support surface 185c. The at least one support element 185b, the at least one roller element 185d, as well as the at least one actuating device 188 coupled to the at least one roller element 185d are arranged in each case in the lower tool part 140. In particular, the at least one support element 185b and roller element 185d are arranged below the at least one cutting element 182.

To support the at least one actuating device 184 (or the at least one cutting element 182) during the cutting (punching) of the sheet of material 10, the at least one roller element 185d is extended. In this case, using the at least one second actuating device 188, the at least one roller element 185d (horizontal) is moved inward (i.e., in the direction of the lower mold half 134), which is indicated by the arrow 44 in FIG. 4. The at least one roller element 185d is brought into a position below the support element 185b by the extension. The overlying support element 185b rests with its (outwardly) tilted support surface 185c on the extended roller element 185d.

The at least one second actuating device 188 is also configured to exert a support force on the at least one extended roller element 185d, which in terms of amount corresponds to approximately the punching force that is exerted during cutting (punching) on the at least one cutting element 182. The upper tool part 120 is now lowered until the at least one opposing cutting element 186 comes into contact with the at least one underlying cutting element 182 and exerts on the latter a desired punching force to cut through the sheet of material 10 (depicted by arrow 42 in FIG. 4). The punching force exerted on the at least one cutting element 182 is essentially compensated for by the support force counteracting the punching force applied by the underlying support mechanism, thus ensuring that stress on the actuating device 184 is reduced.

After the punching process, the first tool part 120 is further lowered. At the same time, the support force built up using the second actuating device 188 can again be reduced. Because of the thus produced force imbalance, the at least one support element 185b together with the at least one cutting element 182 is moved downward (see arrow 45 in FIG. 4, which indicates this movement). Because of the movement of the at least one support element 185b downward, the at least one roller element 185d arranged underneath unrolls outward along the tilted support surface 185c. This movement is diagrammatically indicated by the arrow 46 in FIG. 4. The at least one roller element 185d and the thus interacting support element 185b are then again in their retracted position. The mold tool 100b can now be entirely closed, and the sheet of material 10 can be completely reshaped.

The advantage of the support mechanism described in connection with FIG. 4 consists in that the upper tool part 120 must not be raised again in order to be able to retract the at least one support element 185b and the roller element 185d again using the second actuating device 188. Rather, the at least one roller element 185d is simply pressed outward by the tilted support surface 185c when the upper tool part 120 is moved further onto the lower tool part 140. A brief raising of the upper tool part 120, as further described above in connection with the mold tool 100a, is thus no longer necessary to release the support mechanism for retraction. Thus, the molding process can be further accelerated.

The molding technology described here is suitable in particular for sheets of material that have a lower elasticity in comparison to thermoplastic films and thus are more difficult to reshape. By the production of local cuts (precuts) in the sheet of material, it is possible to flexibilize the latter and thus to improve the reshaping to form three-dimensional articles.

1. A mold tool for reshaping a sheet of material into at least one three-dimensional article, the mold tool comprising:
a first tool part and a second tool part that works together with the first tool part, wherein in a closed state of the mold tool the first tool part and the second tool part are moved toward one another, and in an open state of the mold tool, the first tool part and the second tool part are moved away from one another;
a first mold half arranged in the first tool part and a second mold half arranged in the second tool part, wherein the mold half and the second mold half are configured to reshape the sheet of material arranged between the first tool part and the second tool part into the at least one three-dimensional article when the first tool part and the second tool part are moved toward one another; and
a cutting device comprising at least one cutting element and at least one actuating device coupled to the at least one cutting element, wherein the at least one actuating device extends the at least one cutting element in a direction of the sheet of material arranged between the first tool part and the second tool part in order to cut the sheet of material.

2. The mold tool according to claim 1, wherein the at least one actuating device retracts the at least one cutting element in the direction of the sheet of material when the mold tool is in the open state or in a partially open state.

3. The mold tool according to claim 1, wherein the at least one actuating device retracts the at least one cutting element after the sheet of material is cut.

4. The mold tool according to claim 1, wherein the at least one cutting element is arranged in the mold tool such that in the extended position, the at least one cutting element at least partially precuts or cuts the sheet of material on an outer edge of the at least one three-dimensional article that is to be molded or is already molded or close to the outer edge of the at least one three-dimensional article that is to be molded or is already molded.

5. The mold tool according to claim 1, wherein the at least one cutting element is arranged in the first tool part and/or in the second tool part.

6. The mold tool according to claim 1, wherein the at least one actuating device is arranged in the first tool part and/or in the second tool part.

7. The mold tool according to claim 1, wherein the cutting device comprises at least one opposing cutting element that works together with the at least one cutting element.

8. The mold tool according to claim 7, wherein the at least one opposing cutting element is arranged in the first tool part or the second tool part opposite to the at least one cutting element in an extending position.

9. The mold tool according to claim 1, wherein the at least one cutting element comprises at least one blade.

10. The mold tool according to claim 1, wherein the at least one actuating device comprises an extending and retracting mechanism driven pneumatically, hydraulically, or electromechanically.

11. The mold tool according to claim 1, further comprising at least one support mechanism that supports the at least one cutting element.

12. The mold tool according to claim 1, further comprising at least one cutting line arranged in at least one of the first part and the second tool part for final-cutting the at least one three-dimensional article.

13. The mold tool according to claim 1, wherein the sheet of material comprises natural fibers.

14. A method of using the mold tool according to claim 1 for producing the at least one three-dimensional article from the laminar sheet of material made of natural fibers.

15. A molding machine for producing at least one article from a laminar sheet of material, comprising:
the mold tool according to claim 1;
an over-table which accommodates the first tool part of the mold tool; and
an under-table which accommodates the second tool part of the mold tool wherein the over-table and/or the under-table is/are movably mounted.

16. A method for producing at least one three-dimensional article from a laminar sheet of material, comprising:
arranging the laminar sheet of material between two mold halves of a mold tool;
extending at least one cutting element of the mold tool in a direction of the sheet of material arranged between the two mold halves;
cutting the sheet of material using the at least one cutting element in a case of an open or at least partially open mold tool;
retracting the at least one cutting element after the sheet of material is cut; and
closing of the mold tool and reshaping of the sheet of material to form at least one three-dimensional article.

17. The method according to claim 16, wherein the cutting using the cutting element comprises a precutting of the sheet of material, and wherein the method further comprises:
final-cutting of the formed at least one three-dimensional article to separate the article from the sheet of material.

18. The method according to claim 16, wherein the extending comprises a positioning of the at least one cutting element directly below or above the sheet of material, and wherein the cutting comprises a movement of the tool part, opposite to the at least one cutting element, in a direction of the at least one cutting element, until at least one opposing cutting element comes into contact with the at least one cutting element.

19. The method according to claim 16, wherein the retracting the at least one cutting element comprises moving the tool part with the at least one opposing cutting element away from the at least one cutting element to release the at least one cutting element for retraction.

20. A method for producing at least one three-dimensional article from a laminar sheet of material, comprising:
arranging the laminar sheet of material between two mold halves of a mold tool;
losing the mold tool and reshaping of the sheet of material to form at least one three-dimensional article;
extending at least one cutting element of the mold tool; and
cutting-out, using the at least one extended cutting element, of the at least one three-dimensional article from the sheet of material.
